(19) United States
(12) Patent Application Publication
(10) Pub. No.: US 2008/0098774 A1
(43) Pub. Date: May 1, 2008

(54) Combination and key operated padlock with indicator for advising that the lock has been opened with a key

(76) Inventor: Chien-Chien Huang, Lugaang Village (TW)

Correspondence Address: PRO-TECHTOR INTERNATIONAL SERVICES, 20775 NORADA CT., SARATOGA, CA, 95070, US

(21) Appl. No.: 11/588,531

(22) Filed: Oct. 27, 2006

(51) Int. Cl. E05B 37/02

(52) U.S. Cl. 70/21

(57) ABSTRACT

A combination and key operated padlock is disclosed. Turning the dials to a correct combination will unlock a shackle to align a green indication member with an indicator window and remain same when the lock is locked again by turning the dials to an incorrect combination. Inserting a key into a keyhole and clockwise turning a key turning assembly will unlock the shackle wherein a red indication member moves to align with the indicator window. Counterclockwise turning the key will lock the shackle with the color “red” still displayed through the indicator window so as to advise the owner of the lock that the lock has been opened by means of a key.

### BACKGROUND OF THE INVENTION

1. Field of Invention

The present invention relates to combination and key operated padlocks and more particularly to such a combination and key operated padlock having a spring biased indicator for advising the owner of the lock that the lock has been opened by means of a key.

2. Related Art

Combination and key operated padlocks (i.e., padlocks that can be operated by combination or by key) are well known in the art. For example, U.S. Pat. No. 6,928,842 B01 discloses a combination lock having a key opening mechanism. Also, U.S. Pat. No. 6,792,778 B1 discloses a combination lock. Both patents are specifically incorporated herein by reference and are assigned to Glox Industry Co., Ltd., assignee of the subjective invention.

However, both patents do not disclose a combination and key operated padlock having an indicator for advising the owner of the lock that the lock has been opened with a key. Thus, the need for improvement still exists.

### SUMMARY OF THE INVENTION

It is therefore an object of the present invention to provide a combination and key operated padlock capable of displaying a first color (e.g., color “red”) through an indicator window for advising the owner of the lock that the lock has been opened by means of a key.

To achieve the above and other objects, the present invention provides a lock comprising a housing including a top shackle receiving hole, a top shackle receiving recess, a plurality of dial openings on a surface, an indicator window on the surface, and a bottom keyhole opening; a dial assembly mounted in the housing and including a plurality of wheel-like dials partially projected out of the dial openings, a plurality of sleeves axially moveably fastened in the dials, a spring biased bar axially moveably fastened in the sleeves, an enlargement at the other end of the bar opposite the bottom of the housing, and a ring-shaped detent mounted around the enlargement; a hollow block assembly formed with the enlargement and including a side protuberance, a hollow top projection communicated with an internal space of the block assembly, and a spring biased between an inner surface of the housing and the projection; an activation mechanism partially fitted in the space and including a trough at one end adapted to align with the projection, a push member below the trough, a urging member at the other end, and a cavity in the urging member; a U-shaped shackle including one leg inserted through the shackle receiving hole and the projection into the space, an annular groove proximate a terminating end of one leg and engaged with the trough in a locked position, and the other leg received in the shackle receiving recess in the locked position; a spring biased indicator including a wall at the other end, a first indication member aligned with the indicator window in the locked position for displaying a first color through the indicator window, a second indication member, and a cut at the other end proximate the second indication member and engaged with the protuberance; a pivot assembly partially matingly engaged with the activation mechanism and including a spring biased protrusion at one end and an intermediate riser; a key turning mechanism including a keyhole in the keyhole opening, a shaft of half circular section projected out of one end opposing the keyhole, a rotatable member of cylindrical section including a bore of half circular section at the other end matingly engaged with a portion of the shaft, and an eccentric rod of cylindrical section at one end of the rotatable member fitted in the cavity; and a leaf spring member mounted to one side of the dial assembly and having a plurality of arms pressed against peripheries of the dials to assist in retaining the dials in their current positions, whereby: turning the dials to a correct combination will unlock the bar and pulling the shackle will open the lock, compress the spring, move the indicator upward to align the second indication member with the indicator window for displaying a second color different from the first color through the indicator window, and pass the wall through the protrusion to be locked by the immediately leftward moved protrusion wherein the indicator is held motionless when the lock is locked again by turning the dials to an incorrect combination; inserting a key into the keyhole and clockwise turning the shaft and the rotatable member about half turn will move the eccentric rod and the cavity rightward, cause the trough to clear the groove, and unlock the shackle wherein the riser is pushed rightward by the urging member, the protrusion pivots rightward to unlock the wall, and the indicator moves downward to cause the first indication member to align with the indicator window for displaying the first color through the indicator window; and counterclockwise turning the shaft and the rotatable member about half turn will move the eccentric rod and the cavity leftward, engage the trough with the groove to lock the shackle, and pivotably move the protrusion leftward wherein the first indication member still aligns with the indicator window for displaying the first color through the indicator window.

In one aspect of the present invention the first color is red and the second color is green.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of combination and key operated padlock (i.e., lock) according to the present invention;

FIG. 2 is an exploded view of the lock;

FIG. 3 is a front view of the lock of FIG. 2 with the cover of the housing removed and the shackle locked;

FIG. 4 is a view similar to FIG. 3 with the shackle unlocked by entering a correct combination;

FIG. 5 is a view similar to FIG. 3 with the shackle locked again;

FIG. 6 is a view similar to FIG. 3 with the shackle unlocked by inserting a key into the housing and turning the inserted key;

FIG. 7 is a view similar to FIG. 3 with the shackle locked again after turning the inserted key in an opposite direction where the red indication member is exposed for advising the owner of the lock that the lock has been opened with a key;

FIG. 8 is a perspective view of the lock in FIG. 7 where the red indication member is exposed through the indicator window;

FIG. 9 is a view similar to FIG. 3 with the shackle unlocked and pivoted a predetermined angle relative to the housing after entering a correct combination; and

FIG. 10 is a view similar to FIG. 9 where a combination changing operation of the lock has been completed.

### DETAILED DESCRIPTION OF THE INVENTION

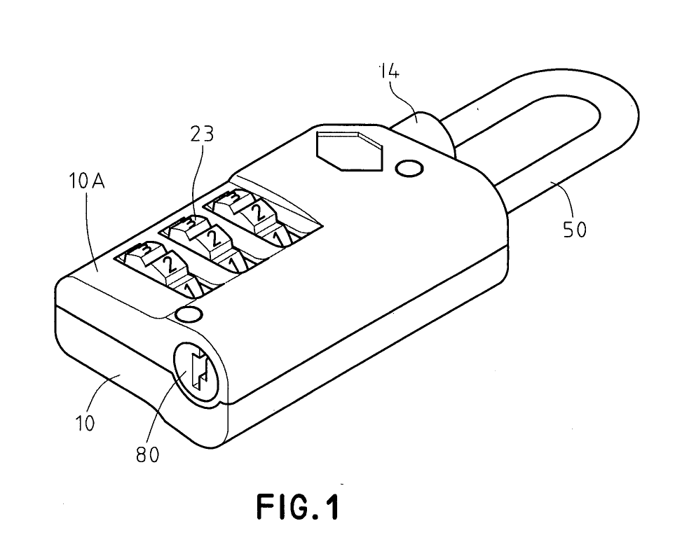

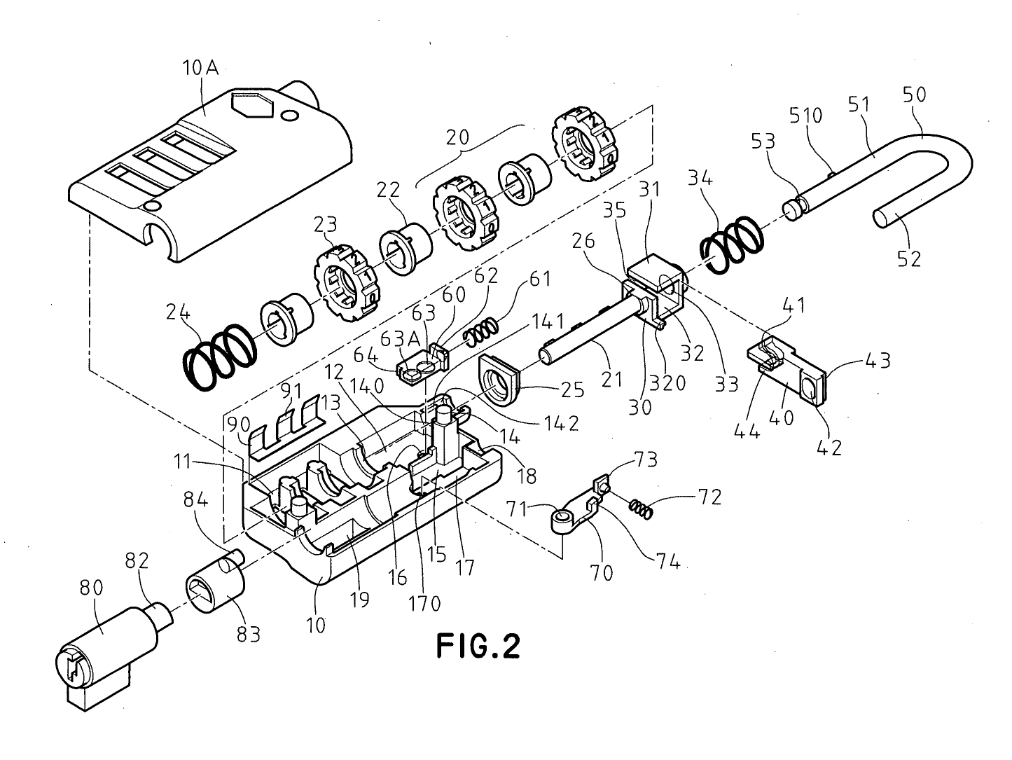

Referring to FIGS. 1 to 10, a combination and key operated padlock (i.e., lock) in accordance with a preferred embodiment of the present invention comprises a housing 10, a dial assembly 20, a block assembly 30, an activation mechanism 40, a U-shaped shackle 50, an indicator 60, a pivot assembly 70, a key turning mechanism 80, and a leaf spring 90. Each component will be described in detail below.

The substantially rectangular housing 10 comprises a cover 10A having a first shackle aperture (not numbered) on a top wall, three rectangular dial openings (not numbered), and a second aperture (not numbered) (i.e., keyhole) on a bottom wall; and a base (not numbered) including three rectangular dial openings (not numbered), a plurality of spaced raised seats 11 having a half circular groove (not numbered) thereon, a first compartment 12 opposite the seats 11, a channel 13 in communication with the compartment 12 and the adjacent seat 11, a shackle receiving member 14 within an element (i.e., a mating member of the shackle aperture) projected from the top wall, the shackle receiving member 14 including two opposite flats 141, a tunnel 140 between the flats 141, and a space 142, a second compartment 15 parallel to the first compartment 12 (i.e., at the side of the base opposing both the first compartment 12 and the seats 11), an indicator window 16 through the bottom of the second compartment 15, a third compartment 17 besides the second compartment 15, a post 170 in the third compartment 17, a shackle receiving recess 18 spaced from the third compartment 17 and open to the external, and a fourth compartment 19 below the third compartment 17 and in communication therewith. The cover 10A is secured onto the housing 10 by a snapping mechanism employing projections and holes well known in the art.

The dial assembly 20 is anchored on the grooves of the seats 11 and comprises three wheel-like dials 23 partially projected out of the dial openings of the housing 10 and having a plurality of teeth around its inner surface, three sleeves 22 fitted in the dials 23, a first spring 24 urged between a bottom wall of the housing 10 and the bottommost sleeve 22, a locking bar 21 having a plurality of sets of locking projections (not numbered) on its peripheral surface of its shank portion, the locking bar 21 inserted through the sleeves 22 into the first spring 24, an enlargement 26 formed at one end of the locking bar 21 opposite the first spring 24, and a ring-shaped detent 25 mounted around the enlargement 26.

The block assembly 30 is formed with the enlargement 26 and comprises a hollow block 31, a space 32 in the block 31, a protrusion 320 projected out of one side, a hole 33 through a top surface and communicated with the space 32, a second spring 34 put on a projected portion which has the hole 33 formed therein, and a gap 35 adjacent the detent 25.

The activation mechanism 40 is an integral member and is partially fitted in the space 32. The elongate activation mechanism 40 comprises a trough 41 at one end adapted to align with the hole 33, a push member 44 below the trough 41, a urging member 43 at the other end, and a cavity 42 in the urging member 43.

The shackle 50 comprises one leg 51 inserted through the second spring 34 and the hole 33 into the space 32, an annular groove 53 proximate a terminating end of one leg 51 and engaged with the trough 41 in a locked position, a protuberance 510 projected out of one leg 51 received in a well in the shackle receiving member 14 in the locked position, and the other leg 52 received in the shackle receiving recess 18 in the locked position.

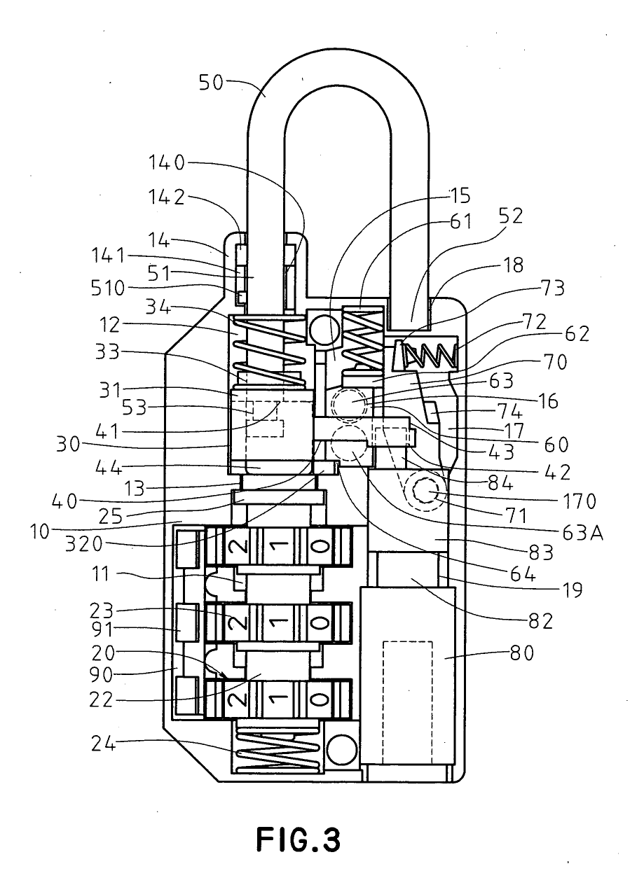

The indicator 60 is slidably anchored in the first compartment 15 and comprises a wall 62 at the other end, a third spring 61 urged between the wall 62 and a wall of the first compartment 15, a red indication member 63 aligned with the indicator window 16 in the locked position (see FIG. 3) i.e., the lock is in a first state with color “red” displayed through the indicator window 16 when the lock is in the locked position, a green indication member 63A, and a cut 64 at one end proximate the green indication member 63A.

The pivot assembly 70 is provided in the third compartment 17 and has a portion matingly engaged with the activation mechanism 40. The elongate pivot assembly 70 comprises a hole 71 at one end pivotably put on the post 170, a protrusion 73 at the other end, a fourth spring 72 having one end put on a short projected member (not numbered) of the protrusion 73 and the other end biased against an inner wall of the third compartment 17, and an intermediate riser 74.

The cylindrical key turning mechanism 80 comprises a rectangular protrusion (not numbered) on a bottom securely mounted in the fourth compartment 19, an outer keyhole (not numbered) at one end (i.e., open end), a shaft 82 of half circular section projected out of the other end, a separate short rotatable member 83 of cylindrical section including a bore of half circular section at one end matingly engaged with a portion of the shaft 82, and an eccentric rod 84 of cylindrical section at the other end of the rotatable member 83 fitted in the cavity 42.

The leaf spring 90 is mounted to one side of the dial assembly 20 and has three arms 91 pressed against the peripheries of the dials 23 to assist in retaining the dials 23 in their current positions.

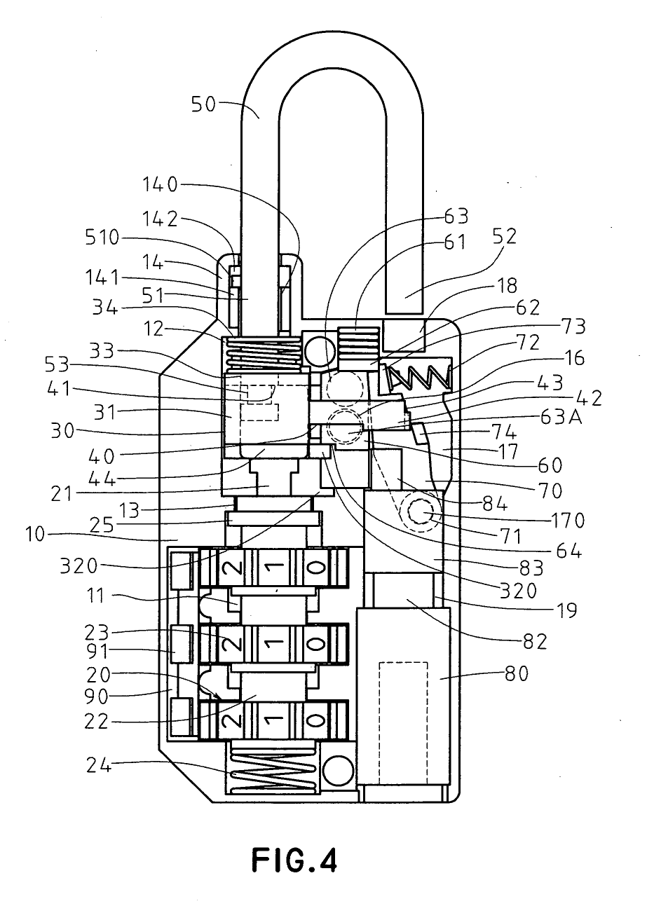

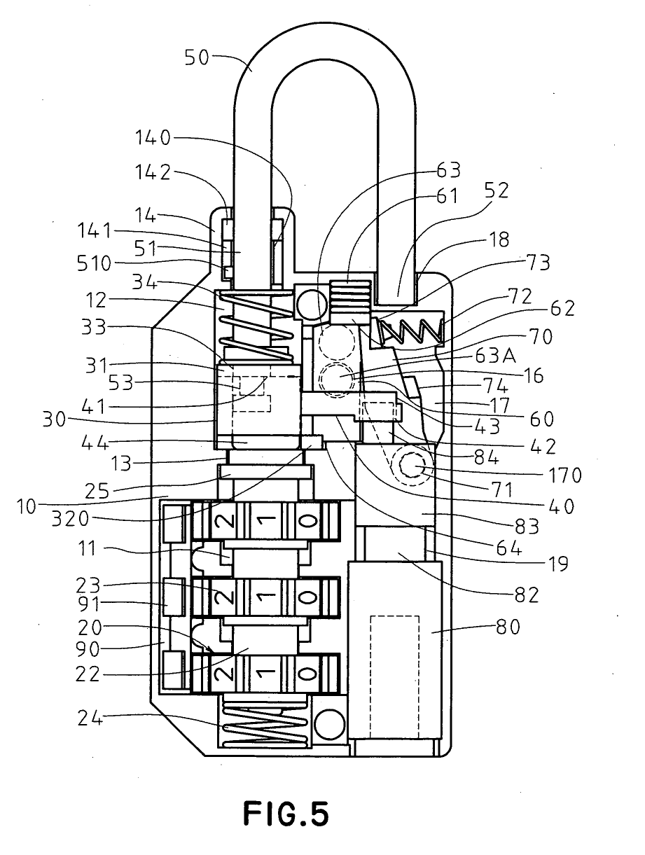

The locked position of the lock is shown in FIG. 3. Referring to FIGS. 4 and 5 again, an owner of the lock can turn the dials 23 until a correct set series of numbers (i.e., combination) are shown on the dial openings of the housing 10. The locking bar 21 is thus unlocked by the sleeves 22. The owner then can pull the other leg 52 of the shackle 50 out of the shackle receiving recess 18 in order to open the lock. As shown in FIG. 4, the second spring 34 is compressed and also the protrusion 320 engaged with the cut 64 moves upward (i.e., the indicator 60 moved upward). As an end, the third spring 61 is compressed. Further, the green indication member 63A is aligned with the indicator window 16 due to its upward movement. That is, the unlocked lock is in a second state with color “green” displayed through the indicator window 16. The wall 62 passes the protrusion 73 of the pivot assembly 70 and is thus immediately locked by the leftward movement of the protrusion 73 (see FIG. 5) due to the expansion of the fourth spring 72. As shown in FIG. 5, the indicator 60 is held motionless even when the lock is locked again by turning the dials 23 to an incorrect set series of numbers (i.e., combination).

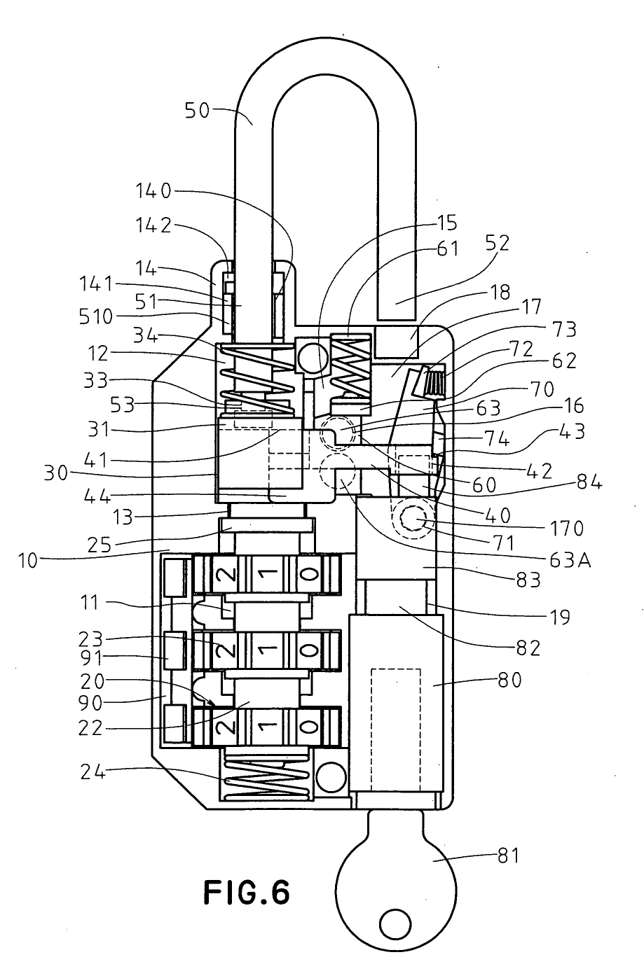

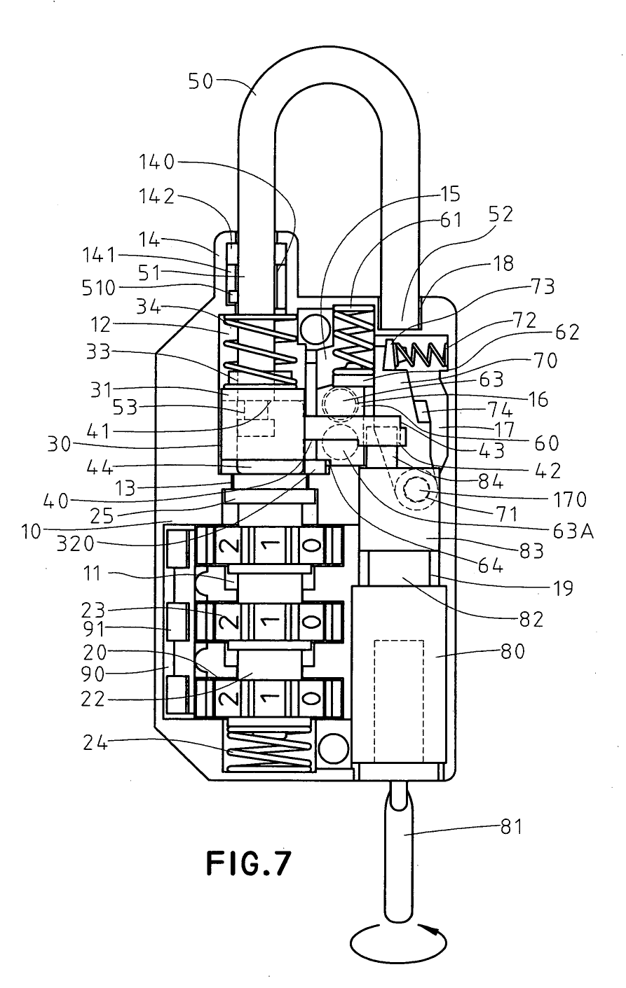

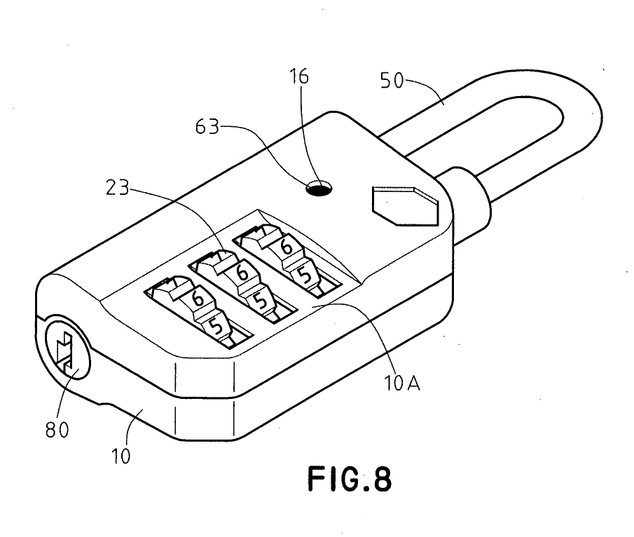

Referring to FIGS. 6, 7, and 8 again, a key opening operation of the lock will now be described in detail below. For example, this is the case of a government employee (e.g., an airport customs officer) inspecting the contents of a locked luggage. The customs officer can insert a key (e.g., an “override” key) 81 into the keyhole to clockwise turn the key turning assembly 80 (i.e., the shaft 82 and thus the rotatable member 83) about half turn so as to move the eccentric rod 84 and thus the cavity 42 rightward (see FIG. 6). As such, the trough 41 clears the groove 53. Hence, the shackle 50 is unlocked. Also, the riser 74 is pushed rightward by the urging member 43 and the fourth spring 72 is thus compressed by the protrusion 73. And in turn, the wall 62 is unlocked and thus moves downward due to the expansion of the third spring 61. The indicator 60 also moves downward to cause the red indication member 63 to align with the indicator window 16. The lock is in a first state with color “red” displayed through the indicator window 16. It is possible of counterclockwise turning the key turning assembly 80 (i.e., the shaft 82 and thus the rotatable member 83) about half turn so as to move the eccentric rod 84 and thus the cavity 42 leftward (see FIG. 7). As such, the trough 41 engages with the groove 53 to lock the shackle 50 again. Also, the pivot assembly 70 pivots leftward with the fourth spring 72. expanded. However, the second state of the lock is unchanged. That is, color “red” is still displayed through the indicator window 16 and the indicator 60 is motionless. Any person (e.g., owner) can check whether the lock has been opened by a key or not by seeing the color displayed through the indicator window 16 (see FIG. 8).

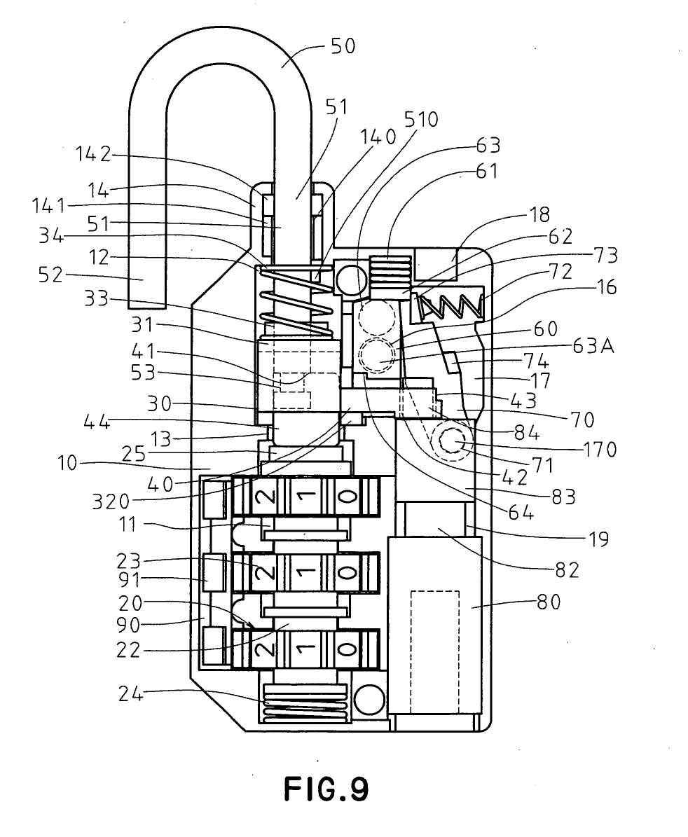

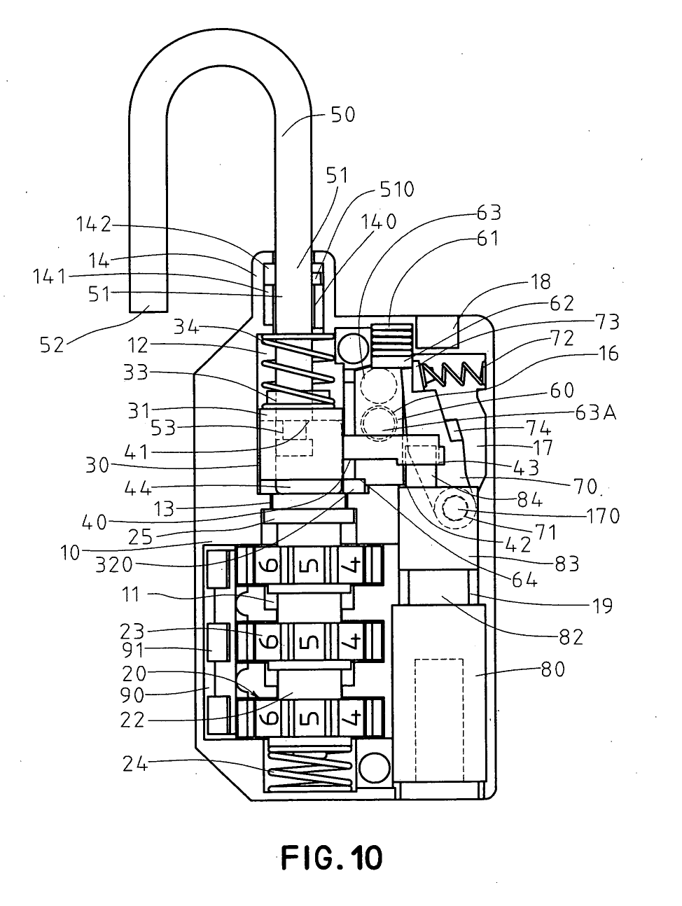

Referring to FIGS. 9 and 10 again, a combination changing operation of the lock, as an allowable operation after opening the lock by turning the dials 23 to the correct set series of numbers (i.e., combination), is illustrated. Pull the other leg 52 out of the shackle receiving recess 18. Next, turn the other leg 52 of the shackle 50 about one leg 51 about half turn. Next, press the shackle 50 to cause the push member 44 to push down the detent 25. As such, the sleeves 22, unlocked by the locking bar 21, move downward along the locking bar 21 to compress the first spring 24. This enables a user to subsequently select any desired combination of numbers to represent the particular combination for opening the lock. After changing the combination, release the shackle 50 will cause the energized first spring 24 to expand. As an end, the sleeves 22 return to its original position. This finishes the combination changing operation.

The present invention has been shown and described in detail, various modifications and improvements thereof will become readily apparent to those skilled in the art. Accordingly, the spirit and scope of the present invention is to be construed broadly and limited only by the appended claims and not by the foregoing specification.

What is claimed is:

1. A lock comprising:
a housing including a top shackle receiving hole, a top shackle receiving recess, a plurality of dial openings on a surface, an indicator window on the surface, and a bottom keyhole opening;
a dial assembly mounted in the housing and including a plurality of wheel-like dials partially projected out of the dial openings, a plurality of sleeves axially moveably fastened in the dials, a spring biased bar axially moveably fastened in the sleeves, an enlargement at the other end of the bar opposite the bottom of the housing, and a ring-shaped detent mounted around the enlargement;
a hollow block assembly formed with the enlargement and including a side protuberance, a hollow top projection communicated with an internal space of the block assembly, and a spring biased between an inner surface of the housing and the projection;
an activation mechanism partially fitted in the space and including a trough at one end adapted to align with the projection, a push member below the trough, a urging member at the other end, and a cavity in the urging member;
a U-shaped shackle including one leg inserted through the shackle receiving hole and the projection into the space, an annular groove proximate a terminating end of one leg and engaged with the trough in a locked position, and the other leg received in the shackle receiving recess in the locked position;
a spring biased indicator including a wall at the other end, a first indication member aligned with the indicator window in the locked position for displaying a first color through the indicator window, a second indication member, and a cut at the other end proximate the second indication member and engaged with the protuberance;
a pivot assembly partially matingly engaged with the activation mechanism and including a spring biased protrusion at one end and an intermediate riser;
a key turning mechanism including a keyhole in the keyhole opening, a shaft of half circular section projected out of one end opposing the keyhole, a rotatable member of cylindrical section including a bore of half circular section at the other end matingly engaged with a portion of the shaft, and an eccentric rod of cylindrical section at one end of the rotatable member fitted in the cavity; and
a leaf spring member mounted to one side of the dial assembly and having a plurality of arms pressed against peripheries of the dials to assist in retaining the dials in their current positions, whereby:
turning the dials to a correct combination will unlock the bar and pulling the shackle will open the lock, compress the spring, move the indicator upward to align the second indication member with the indicator window for displaying a second color different from the first color through the indicator window, and pass the wall through the protrusion to be locked by the immediately leftward moved protrusion wherein the indicator is held motionless when the lock is locked again by turning the dials to an incorrect combination;
inserting a key into the keyhole and clockwise turning the shaft and the rotatable member about half turn will move the eccentric rod and the cavity rightward, cause the trough to clear the groove, and unlock the shackle wherein the riser is pushed rightward by the urging member, the protrusion pivots rightward to unlock the wall, and the indicator moves downward to cause the first indication member to align with the indicator window for displaying the first color through the indicator window; and
counterclockwise turning the shaft and the rotatable member about half turn will move the eccentric rod and the cavity leftward, engage the trough with the groove to lock the shackle, and pivotably move the protrusion leftward wherein the first indication member still aligns with the indicator window for displaying the first color through the indicator window.

2. The lock of claim 1, wherein the first color is red.

3. The lock of claim 1, wherein the second color is green.
